(19) United States
(12) Patent Application Publication
(10) Pub. No.: US 2013/0186373 A1
(43) Pub. Date: Jul. 25, 2013

(54) MITIGATION OF FUEL PRESSURE SPIKES IN A FUEL INJECTOR HAVING INDEPENDENTLY CONTROLLED PRESSURE INTENSIFICATION AND INJECTION

(71) Applicant: Dean Alan Oppermann, Plainfield, IL (US)

(72) Inventor: Dean Alan Oppermann, Plainfield, IL (US)

(73) Assignee: International Engine Intellectual Property Company, LLC., Lisle, IL (US)

(21) Appl. No.: 13/641,170

(22) PCT Filed: Apr. 15, 2010
(86) PCT No.: PCT/US10/31162

§ 371 Date: Mar. 18, 2013

(51) Int. Cl. F02D 41/40

(52) U.S. Cl. CPC F02D 41/401
USPC 123/480

(57) ABSTRACT

A pressure intensifier (64) is controlled by a control valve (ICV 66) to intensify pressure with which fuel is injected from an outlet port (40) of an injection device (20) into an engine cylinder in comparison to that at which fuel is introduced. A controller operates both a needle control valve (NCV 54) and the ICY valve during an engine cycle to cause: intensified pressure to be applied to fuel in the injector while the fuel outlet port is closed; then the outlet port to open while intensified pressure continues to be applied as fuel is injected; then while the outlet port remains open and fuel injection continues, the intensified pressure attenuates; then after the intensified pressure has attenuated, the outlet port is re-closed to terminate injection; and then the outlet port is re-opened and the attenuated pressure re-intensified to inject fuel at re-intensified pressure.

### TECHNICAL FIELD

This disclosure relates generally to internal combustion engines having cylinders into which fuel is injected, and more particularly to fuel injection devices and methods for direct injection of liquid fuel into the cylinders and its ensuing combustion in air that has been compressed by pistons that reciprocate within the cylinders.

### BACKGROUND OF THE DISCLOSURE

A known electronic engine control system comprises a processor-based engine controller that processes data from various sources to develop control data for controlling certain functions of the engine, including fueling of the engine by fuel injectors that inject fuel directly into engine cylinders. The fuel injectors have ports communicated to fuel under pressure in a fuel rail. Control of engine fueling encompasses both the duration of an injection of fuel and the timing of the injection so that the control system thereby sets both the amount of fuel injected and the time at which injection occurs during an engine cycle.

During an engine cycle, a main injection of fuel may be preceded by one or more pre-injections (pilot injections) and/or followed by one or more post-injections. Consequently, an engine cycle may at times comprise multiple discrete injections of fuel.

One type of fuel injector comprises a mechanism for controlling opening and closing of a needle valve at the injector tip. When the mechanism operates the needle valve open, fuel is injected from the tip into the corresponding engine cylinder by pressure that is being applied to the fuel. When the mechanism operates the needle valve closed, fuel is not injected from the tip. An example of such a mechanism comprises a fast-acting, electrically-operated needle control valve (NCV) for quickly operating the needle valve open and closed.

Such a fuel injector may also have an associated intensifier mechanism that can intensify the pressure of fuel being injected. For example, an intensifier mechanism can comprise an intensifier control valve (ICV) that is communicated to oil in an oil rail to operate a plunger within the fuel injector to intensify, i.e. amplify, the pressure at which fuel is being injected. The fuel injection pressure correlates with oil rail pressure that is applied through the intensifier control valve to the plunger. The pressure in the oil rail is itself controlled by a control strategy that is an element of the overall engine control strategy implemented in the engine control system.

### SUMMARY OF THE DISCLOSURE

Briefly, the present disclosure relates to a strategy that is implemented in a controller for a fuel injection device for performing a method of fuel injection that mitigates pressure spikes that might otherwise occur when the device performs multiple discrete injections were a pressure intensifier mechanism in the device to provide continuous pressure intensification.

One generic aspect of the disclosed subject matter relates to a device for injecting fuel into a cylinder of an internal combustion engine.

The device comprises a fuel inlet port at which fuel is introduced into the device, a fuel outlet port at which fuel is injected from the device, a needle valve for opening and closing the fuel outlet port, a needle control valve for operating the needle valve to open and close the fuel outlet port, a pressure intensifier mechanism controlled by an intensifier control valve for intensifying pressure with which fuel is injected from the device in comparison to that at which fuel is introduced into the device; and a controller for operating the needle control valve and the intensifier control valve during an engine cycle.

The controller causes intensified pressure to be applied to fuel in the injector while the fuel outlet port is closed, then the fuel outlet port to open while intensified pressure continues to be applied as fuel is being injected, then while the fuel outlet port remains open and fuel continues being injected, the intensified pressure to attenuate, then after the intensified pressure has attenuated, the fuel outlet port to be re-closed to terminate injection, and then the fuel outlet port to be re-opened and the attenuated pressure re-intensified to inject fuel at re-intensified pressure.

Another generic aspect a method of operating a fuel injection device for injecting fuel into an internal combustion engine cylinder within which fuel is compressed and combusted to power the engine.

The method comprises operating a needle control valve that opens and closes a fuel outlet port from which fuel that is introduced into the device via a fuel inlet port is injected into the cylinder and an intensifier control valve that controls a pressure intensifier mechanism for intensifying pressure at which fuel is being injected during an engine cycle in comparison to that at which fuel is introduced into the device to cause: intensified pressure to be applied to fuel in the injector while the fuel outlet port is closed; then the fuel outlet port to open while intensified pressure continues to be applied as fuel is being injected; then while the fuel outlet port remains open and fuel continues being injected, the intensified pressure to attenuate; then after the intensified pressure has attenuated, the fuel outlet port to be re-closed and terminate injection; and then the fuel outlet port to be re-opened and the attenuated pressure re-intensified for injecting fuel at re-intensified pressure.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is cross section view through a fuel injector of the type that has a pressure intensifying mechanism.

FIG. 2 is an enlarged view of a lower portion of the fuel injector of FIG. 1 during non-injection.

FIG. 3 is a view similar to FIG. 2 near the beginning of an injection.

FIG. 4 is a view similar to FIG. 3 near the end of the injection.

FIG. 5A shows a series of traces related to operation of the fuel injector.

FIG. 5B shows another series of traces related to operation of the fuel injector.

FIG. 6 shows several waveforms for the timing of certain functions in the fuel injector.

FIG. 7 shows several other waveforms for the timing of the functions.

FIG. 8 is a graph plot comparing two traces of injection pressure vs. time for showing effectiveness of the disclosed system and method in mitigating pressure spikes in the fuel injector.

### DETAILED DESCRIPTION

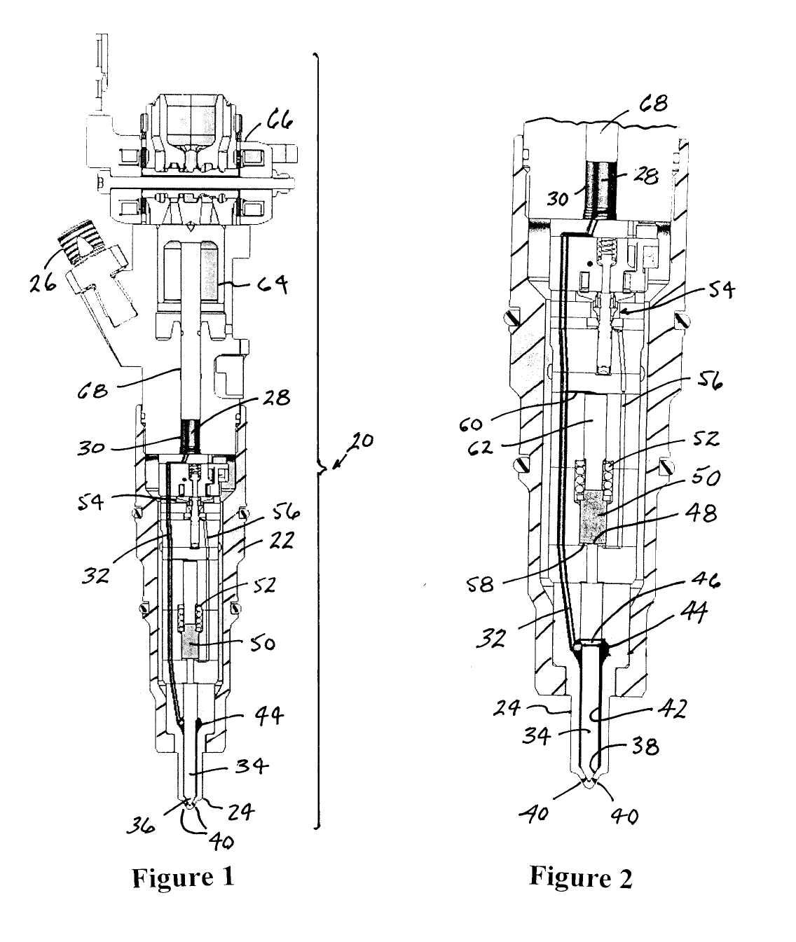

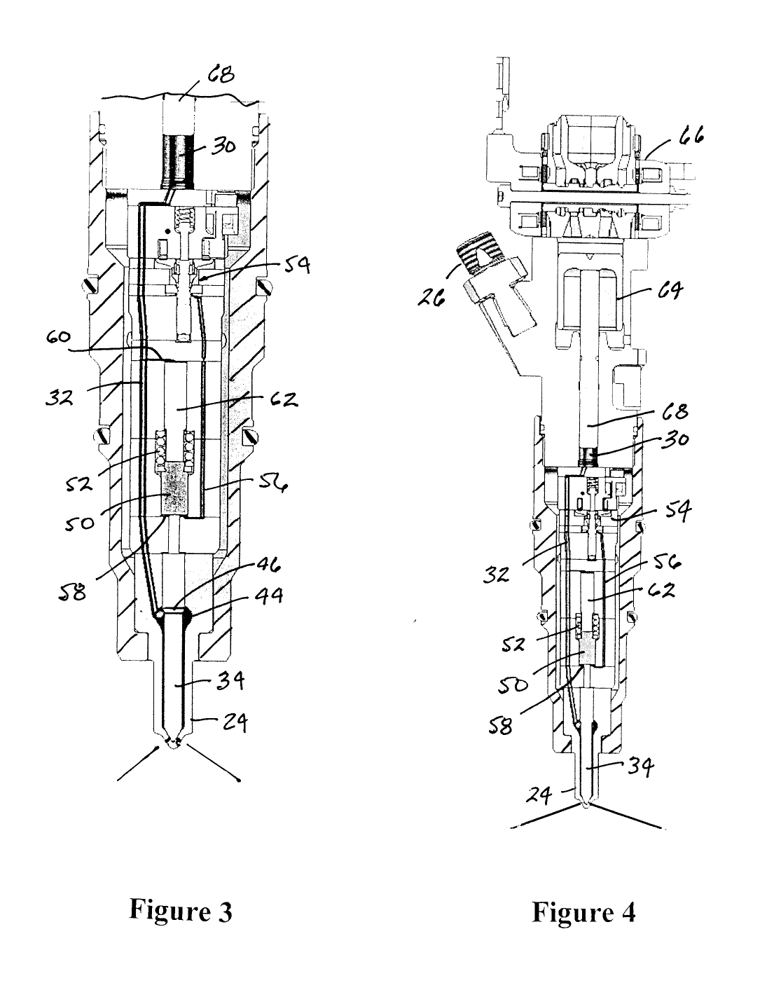

FIG. 1 shows an example of a fuel injector 20 comprising a body 22 that mounts on a cylinder head of an engine (not shown) to expose a tip end 24 to the head end of a cylinder bore within which a piston (also not shown) reciprocates. Fuel injector 20 is intended for use with a diesel engine to inject diesel fuel directly into the cylinder where the fuel combusts in air that has been compressed by the piston to downstroke the piston and impart torque to an engine crankshaft to which a piston rod is coupled.

Fuel under pressure is supplied to an inlet port 26 to fill an internal volume 28 within body 22. A portion of that volume as seen in FIG. 1 includes a variable volume cylindrical chamber 30 and a channel 32 running from chamber 30 toward tip end 24.

A needle 34 is disposed within tip end 24 and shown in FIGS. 1 and 2 to comprise a pointed end 36 that is seated on a complementary shaped internal seat 38 to close small through-holes 40 that collectively form a fuel outlet port in tip end 24. Needle 34 is displaceable axially within a bore 42 that extends internally of tip end 24 from seat 38.

The internal fuel volume 28 includes an annular space 44 at a terminus of channel 32 surrounding a shoulder 46 of needle 34 that is intermediate pointed end 36 and a flat end surface 48 opposite tip end 34 in abutment with an end face of a movable stop 50 that is one element of a needle control mechanism that also comprises a spring 52 for resiliently biasing stop 50 against end surface 48 thereby biasing needle 34 toward seating on seat 38.

Injector 20 further comprises a fast-acting, electrically-actuated needle control valve (NCV) 54 that quickly operates the needle control mechanism. When not actuated, NCV 54 closes a channel 56 that runs from valve 54 to an internal space 58 at the interface where end surface 48 is abutting stop 50. A branch 60 from channel 32 communicates fuel to a space to which one end of another element 62 of the needle control mechanism is exposed.

When channel 56 is closed because NCV 54 is not being actuated, the combination of hydraulic and spring forces acting on needle 34 and its control mechanism cause end 36 to seat on seat 38, but with the needle and control mechanism being in substantial hydraulic pressure balance due to the downward fuel pressure being applied by branch 60 to one end of element 62 and the opposing upward pressure being applied by the fuel in annular space 44 to shoulder 46. When NCV 54 is actuated, it opens channel 56 to allow fuel to flow to space 58 and exert pressure on stop 50 that overcomes the bias and moves the stop away from the needle, allowing hydraulic force acting on the needle to also move and unseat the needle from seat 38. There is sufficient clearance between the needle and bore 42 for fuel to pass from space 44 to through-holes 40 where it is injected from the injector into the engine cylinder.

Injector 20 also comprises an associated intensifier mechanism 64 for intensifying the pressure of fuel being injected. Intensifier mechanism 64 comprises an intensifier control valve (ICV) 66 to which oil under pressure in an oil rail is supplied. ICV 66 controls fluid communication of oil to one end of a plunger 68 within injector 20. The opposite end of plunger 68 is exposed to fuel in the injector. By controlling pressure applied to the plunger through valve 66, the plunger can impart a corresponding degree of intensification, i.e. amplification, of the pressure at which fuel is being injected.

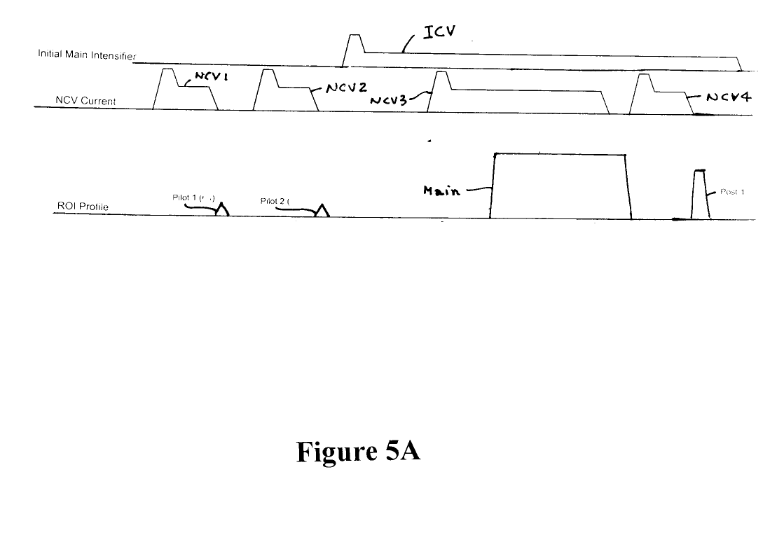

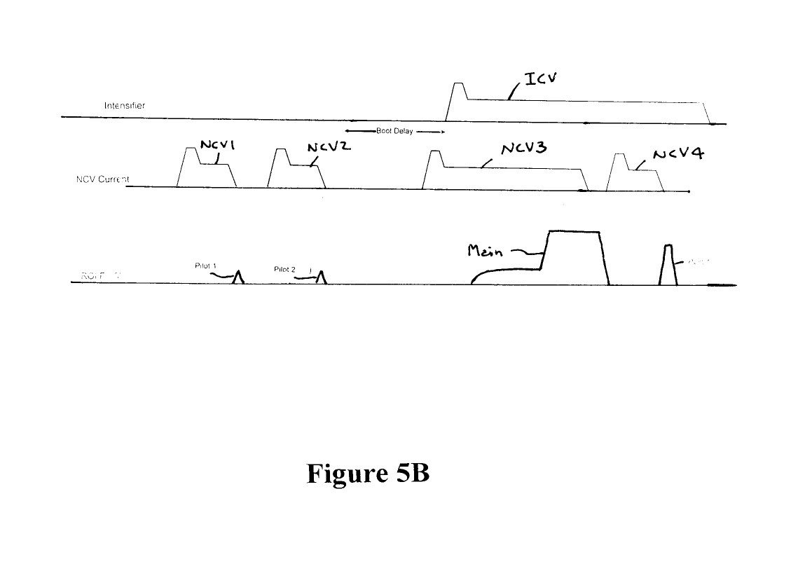

FIG. 5A shows one example of how fuel may be injected during an engine cycle. NCV 54 is actuated twice (NCV1 and NCV2 current signals) without pressure intensification to cause two pilot injections (Pilot 1 and Pilot 2). The injections commence in delayed relation to commencement of the respective actuations of valve 54 because of inherent mechanical and hydraulic response times. The Figure shows rate of injection (ROI) as a function of time.

After pilot injection Pilot 2, ICV 66 is actuated (ICV signal), allowing oil pressure to act on plunger 68 while NCV 54 remains closed. This intensifies the pressure of fuel that is in the injector because a one-way valve (not shown) prevents backflow of fuel trapped in the injector to fuel inlet port 26. With the pressure having been intensified, NCV 54 is actuated (NCV3 current signal) to cause a main injection of fuel (Main in the Figure). While pressure remains intensified after the main injection ends and continues to be intensified while NCV 54 is again actuated (NCV4 current signal) to cause a post-injection (Post 1). Thereafter, ICV 66 closes to stop intensification.

FIG. 5B shows another example. NCV 54 is again actuated twice without pressure intensification to cause the two pilot injections. However, after the second pilot injection, oil pressure is not allowed to act on plunger 68 until after NCV 54 opens. This creates a main injection of fuel that occurs at a slower rate before intensification becomes effective and at a faster rate after intensification becomes effective. Pressure remains intensified after actuation of NCV 54 ends to terminate the main injection. Thereafter NCV 54 is again actuated to cause a post-injection. Various look-up tables in the control strategy are used for controlling timing of both NCV and ICV actuation to produce desired injection patterns. Initiation of intensification in FIG. 5B is delayed from that in FIG. 5A by a “Boot Delay” time that gives the main injection in FIG. 5B a boot-like shape.

In order to mitigate pressure spikes that might otherwise occur in the fuel injector because of continued pressure intensification between successive discrete injections, such as NVC3 and NCV4, actuation of ICV 66 is controlled in relation to actuation of NCV 54 during an engine cycle according to the following strategy.

ICV 66 is actuated to cause intensified pressure to be applied to fuel trapped in the injector while needle 34 is kept seated on seat 38 closing through-holes 40. Then with the pressure intensified, NCV 54 is actuated to unseat needle 34 and open through-holes 40, allowing fuel to be injected while intensified pressure continues to be applied to the fuel. Then while needle 34 is still unseated, actuation of ICV 66 is stopped and the pressure being applied to the fuel consequently attenuates, either fairly substantially or entirely. Then after the pressure has attenuated, actuation of NCV 54 ceases, causing the injector to terminate injection. Then NCV 54 is re-actuated to unseat needle 34 and ICV 66 is also re-actuated to intensify the pressure causing a second injection to occur at intensified pressure.

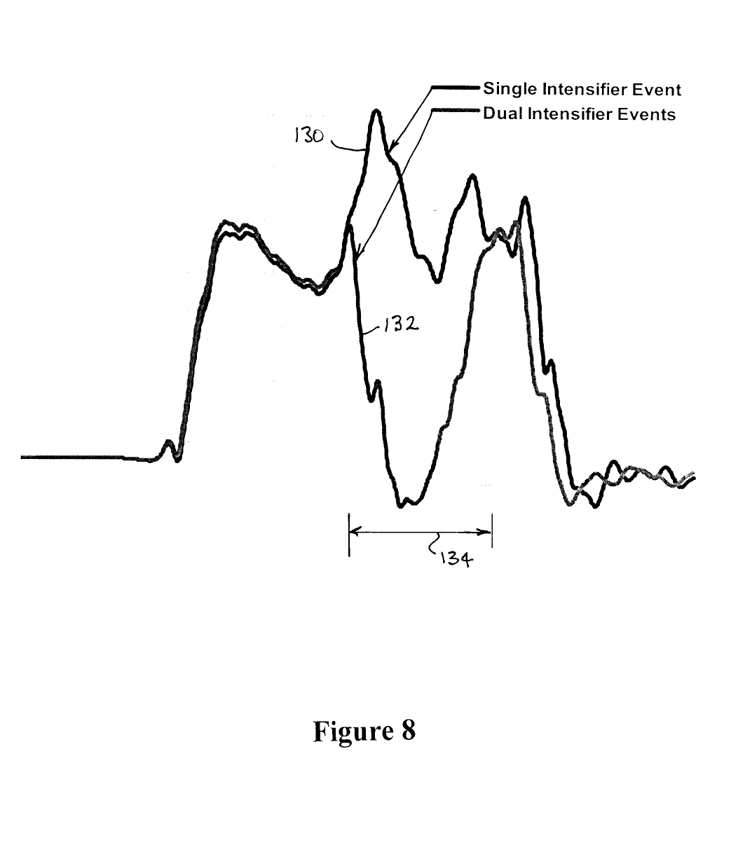

By attenuating the intensified pressure that was used for the first injection, either fairly substantially or entirely, before the immediately following discrete injection is allowed to occur at intensified pressure, pressure spikes may be avoided, as shown by comparing the traces 130, 132 in FIG. 8. The trace 130 marked “single intensifier event” (meaning no attenuation of intensification between injections) shows two pressure peaks (spikes) in the zone marked 134 in comparison to the trace 132 marked “dual intensifier events” (meaning fairly substantial or complete attenuation) which doesn't show such spikes.

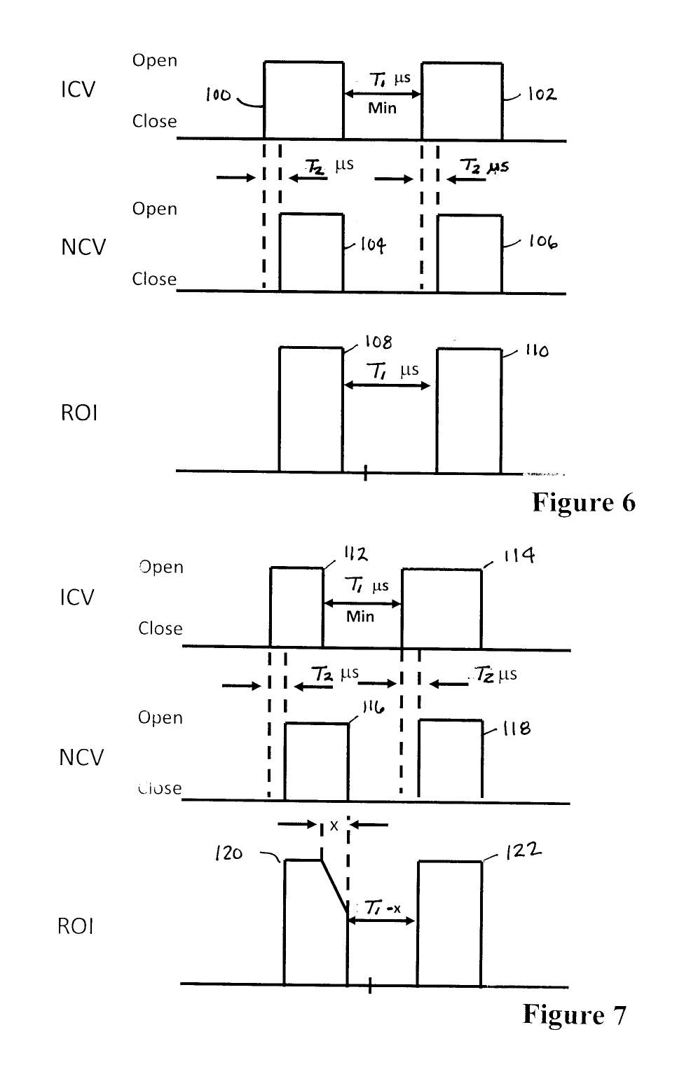

FIG. 6 shows a first series of three waveforms (not necessarily to scale or in precise phase relation) that are representative of the strategy that has been described. Pulses 100, 102 of the first waveform represent successive actuations of ICV 66; pulses 104, 106 of the second waveform represent successive actuations of NCV 54; and pulses 108, 110 of the third waveform represent rate of fuel injection resulting from such actuations.

Pulse 102 commences some length of time after pulse 100 has terminated. That length of time is sufficiently long for the intensified pressure that was created during pulse 102 to attenuate, either fairly substantially or entirely. T₁ μseconds is an example of a sufficient length of time for allowing pressure to attenuate in a particular fuel injector and mitigate pressure spikes that might occur when NCV 54 closes. A delay of T₂ μseconds in actuating NCV 54 in each instance after ICV 66 has been actuated is an example of a length of time suited for allowing the desired intensification to be attained.

FIG. 7 shows a second series of three waveforms (not necessarily to scale or in precise phase relation) that are also representative of the strategy that has been described. Pulses 112, 114 of the first waveform represent successive actuations of ICV 66; pulses 116, 118 of the second waveform represent successive actuations of NCV 54; and pulses 120, 122 of the third waveform represent rate of fuel injection resulting from such actuations.

FIG. 7 differs from FIG. 6 in that pulse 112 has a narrower width than pulse 100, meaning that ICV 66 is open for a shorter time. The same T₂ μsecond delay applies to each actuation of NCV 54 relative to the corresponding actuation of ICV 66. Because of the shortened on time of ICV 66, ROI begins to decrease as fuel pressure begins to attenuate, reducing the momentum of plunger 68 over the interval marked by the reference time x. Because of the reduced momentum of the plunger when needle 34 re-seats, both ICV 66 and NCV 54 can be once again actuated sooner than in the case of FIG. 6, such as T₁-x μseconds sooner for example. This makes the commencement of an injection at re-intensified pressure a decreasing function of the length of time during which the rate of injection was being reduced after the intensifier control valve had closed.

What is claimed is:

1. A device for injecting fuel into a cylinder of an internal combustion engine, the device comprising:
a fuel inlet port at which fuel is introduced into the device;
a fuel outlet port at which fuel is injected from the device;
a needle valve for opening and closing the fuel outlet port;
a needle control valve for operating the needle valve to open and close the fuel outlet port;
a pressure intensifier mechanism controlled by an intensifier control valve for intensifying pressure with which fuel is injected from the device in comparison to that at which fuel is introduced into the device;
and
a controller for operating the needle control valve and the intensifier control valve during an engine cycle to cause: intensified pressure to be applied to fuel in the injector while the fuel outlet port is closed; then the fuel outlet port to open while intensified pressure continues to be applied as fuel is being injected; then while the fuel outlet port remains open and fuel continues being injected, the intensified pressure to attenuate; then after the intensified pressure has attenuated, the fuel outlet port to be re-closed to terminate injection; and then the fuel outlet port to be re-opened and the attenuated pressure re-intensified to inject fuel at re-intensified pressure.

2. A device as set forth in claim 1 wherein while the intensified pressure is attenuating, the controller causes the fuel outlet port to be kept open long enough to allow the rate of fuel injection to decrease over some length of time before re-closing.

3. A device as set forth in claim 2 wherein controller causes the intensifier control valve to re-open for re-intensifying pressure and the needle control valve to re-open and commence an injection at re-intensified pressure upon elapse of a length of time after the closing of the intensification control valve that is a decreasing function of the length of time during which the rate of injection was being reduced after the intensifier control valve had closed.

4. A method of operating a fuel injection device for injecting fuel into an internal combustion engine cylinder within which fuel is compressed and combusted to power the engine, the method comprising,
operating a needle control valve that opens and closes a fuel outlet port from which fuel that is introduced into the device via a fuel inlet port is injected into the cylinder and an intensifier control valve that controls a pressure intensifier mechanism for intensifying pressure at which fuel is being injected during an engine cycle in comparison to that at which fuel is introduced into the device to cause: intensified pressure to be applied to fuel in the injector while the fuel outlet port is closed; then the fuel outlet port to open while intensified pressure continues to be applied as fuel is being injected; then while the fuel outlet port remains open and fuel continues being injected, the intensified pressure to attenuate; then after the intensified pressure has attenuated, the fuel outlet port to be re-closed and terminate injection; and then the fuel outlet port to be re-opened and the attenuated pressure re-intensified for injecting fuel at re-intensified pressure.

5. A method as set forth in claim 4 in which the fuel outlet port is kept open long enough to allow the rate of fuel injection to decrease over some length of time before re-closing.

6. A method as set forth in claim 5 in which the intensifier control valve re-opens for re-intensifying pressure and the needle control valve re-opens to commence injection upon elapse of a length of time after the closing of the intensification control valve that is a decreasing function of the length of time during which the rate of injection was being reduced after the intensifier control valve had closed.
